(19) United States
(12) Patent Application Publication
(10) Pub. No.: US 2023/0301463 A1
(43) Pub. Date: Sep. 28, 2023

(54) COFFEE GROUNDS COLLECTOR

(71) Applicant: NICHOLSON DESIGN CONSULTANTS LIMITED, Waterlooville (GB)

(72) Inventor: Martin NICHOLSON, Waterlooville (GB)

(73) Assignee: NICHOLSON DESIGN CONSULTANTS LIMITED, Waterlooville (GB)

(21) Appl. No.: 18/019,192

(22) PCT Filed: Aug. 10, 2021
(86) PCT No.: PCT/EP2021/072305

§ 371 Date: Feb. 1, 2023

(30) Foreign Application Priority Data
Aug. 10, 2020 (GB) 2012432.7

(51) Int. Cl. A47J 42/40

(52) U.S. Cl. CPC A47J 42/40

(57) ABSTRACT

The present invention relates to a collector for ground beans, for example a collector for coffee grounds and a grounds collection and measurement device for use in a bean grinding apparatus, for example a coffee grinder.

### CROSS-REFERENCE TO RELATED APPLICATIONS

The present application is a national phase application of PCT Application No. PCT/EP2021/072305, filed Aug. 10, 2021, entitled “COFFEE GROUNDS COLLECTOR”, which claims the benefit of Great Britain Patent Application No. 2012432.7, filed Aug. 10, 2020, each of which is incorporated by reference in its entirety.

### BACKGROUND OF THE INVENTION

### 1. Field of the Invention

The present invention relates to a collector for ground beans, for example a collector for coffee grounds, and a grounds collection and measurement device for use in a bean grinding apparatus, for example a coffee grinder.

### 2. Description of the Related Art

Optimum beverages, such as coffee, are best produced from precise quantities of fresh, just ground, roast coffee beans.

For this, it is desirable to provide a grind flow path that is as near to vertical as possible and free from any areas where the grounds can collect and be trapped.

A suitable bean grinder is described in International PCT Patent Application published as WO2018/211264 (incorporated herein by reference) wherein there is provided a bean grinding apparatus comprising a body; grinding burrs mounted in the body, the burrs comprising a non-driven burr and a rotationally driven burr, the rotationally driven burr having a rotational axis about which it rotates; a drive motor operatively coupled to the rotationally driven burr; a grounds flow path defined within the body; and an exit spout, the exit spout having an inlet in communication with the grounds flow path and an outlet, wherein the exit spout defines a longitudinal axis and the longitudinal axis of the exit spout is angled with respect to the rotational axis of the driven burr.

### SUMMARY OF THE INVENTION

In addition to providing an improved grind flow path, it is also desirable to provide a collector for grounds which is free from any areas where the grounds can collect and be trapped and which permits free flow of grounds into and out of the collector in order to eliminate waste resulting from retained grounds and facilitate efficient, effective and uniform filling of a filter for use in a machine used to brew coffee, in particular a filter basket of a portafilter for use in an espresso machine.

According to a first aspect of the invention, there is provided a grounds collector comprising a receptacle having an inner wall and an outer wall wherein an inwardly facing surface of the inner wall defines a hollow within the receptacle, characterised in that the inwardly facing surface of the inner wall has a roughness measured as Ra of less than 0.8 μm and wherein a lower portion of the inner surface of the inner wall forms a substantially continuously concave surface.

The hollow defines a grounds receiving portion of the collector and may be considered to form a reservoir which is open at its top.

In this context, concave means that the inwardly facing surface of the inner wall curves inwards like the interior of a circle or sphere. Suitably the radius of curvature is greater than 5 mm, optionally greater than 6 mm, 7 mm, 8 mm, 9 mm, 10 mm, 15 mm or 20 mm.

In this context ‘substantially continuously concave’ surface means that the lower portion of the inwardly facing surface is concave but may include a central planar portion wherein the diameter of the central planar portion may be less than 25%, less than 20%, less than 15%, or less than 10% of the diameter of the grounds collector receptacle.

Thus, the grounds collector may comprise an inner wall having an upper portion, a bottom portion and transition portion which joins the upper portion to the bottom portion, wherein the transition portion forms a substantially continuously concave surface; or it may comprise an upper portion and a lower portion, wherein the lower portion forms a substantially continuously concave surface.

The inner wall is suitably spaced from the outer wall other than at a connecting portion which connects the inner wall to the outer wall.

A skilled person will appreciate that the roughness value Ra is calculated on a profile and is the arithmetic average value of filtered roughness profile determined from deviations about the centre line within the evaluation length. Rq is the root mean square average determined from deviations about the centre line within the evaluation length. Rt is the range of the collected roughness data points. The profile roughness parameters are defined in the international standard ISO 4287:1997, incorporated herein by reference.

The Ra value may be less than 0.7, less than 0.6, less than 0.5, less than 0.4, less than 0.3, less than 0.25, less than 0.2, less than 0.15, less than 0.1 or less than 0.05 μm.

The Rq value may be less than 0.8, less than 0.7, less than 0.6, less than 0.5, less than 0.4, less than 0.3, less than 0.25, less than 0.2, less than 0.15, less than 0.1 or less than 0.05 μm.

The Rt value may be less than 4, less than 3.5, less than 3, less than 2.5 less than 2, less than 1.5, less than 1, less than 0.75 or less than 0.5 μm.

The roughness of the inwardly facing surface of the inner wall may be categorised as N6 or below, i.e., N6, N5, N4, N3, N2 or N1 as defined in the international standard ISO 1302:2002, incorporated herein by reference.

In an embodiment of the invention, the inwardly facing surface of the inner wall comprises a material selected from metals, polymeric materials, and silicate glasses.

In a further embodiment of the invention, the inwardly facing surface of the inner wall comprises a polished metal, including but not limited to stainless steel and aluminium.

In a yet further embodiment, the inwardly facing surface of the inner wall comprises bright polished stainless steel, typically designated as 1P or 2P according to EN 10088-2:2014, or #7 or #8 according to ASTM A480/A480M:2018.

In an alternative further embodiment of the invention, the inwardly facing surface of the inner wall comprises a polished polymeric material, including but not limited to polished acrylic (poly(methyl methacrylate), poly(methyl 2-methylpropenoate)).

In an alternative further embodiment of the invention, the inwardly facing surface of the inner wall comprises a polished silicate glass.

It is known that grinding beans, such as coffee beans, can generate relatively high levels of static charge on the resulting fine ground particles, especially during certain weather conditions. It is generally found that the finer the grind, the more static charge is created. Fine grounds are very light weight, so are significantly affected by the applied static charge. This can make the grinds stick to the surfaces of the grounds collector or be urged away from the collector.

It is known that the electrostatic charge generated by triboelectric effect between two surfaces can increase with surface roughness. Hence the low surface roughness of the inwardly facing surface of the grounds collector receptacle may also minimize static electricity.

Suitably, the grounds collector is for use in a bean grinding apparatus. The grounds collector may comprise a locating aperture in the outer wall. Suitably, the locating aperture is configured to cooperate with a protuberance (e.g. a lug or pin) located on the bean grinding apparatus such that the grounds collector may be detachably coupled to the bean grinding apparatus in use.

In this context, the term “aperture” includes a through-hole formed through a portion of the outer wall, a cavity formed in a portion of the outer wall, and a notch formed in a peripheral edge portion of the outer wall.

In order to increase stability of the grounds collector, a weight may be located between the inner wall and the outer wall. The weight is suitably located at the bottom of the collector. By placing a weight towards the bottom of the collector, the centre of gravity of the collector is lowered, which results in increased stability.

The weight is suitable formed from a metal. In embodiments in which the weight is formed from a metal, the metal may be a ferromagnetic material, such as iron or a ferromagnetic iron alloy. In such embodiments, the grounds collector may be retained in the desired position relative to a bean grinding apparatus via a magnetic coupling. In other words, the bean grinding apparatus may include a magnetic component in a base thereof and the grounds collector may be magnetically coupled to the base.

As noted above, the inner wall and the outer wall may be formed from a metal. In such embodiments, the grounds collector may include a connecting portion which connects the inner wall to the outer wall. In such embodiments, the connecting portion may comprise a weld which joins the inner wall to the outer wall. The connecting portion is suitably located at an upper end of the grounds collector. Thus, the inner wall may be connected to the outer wall at an upper end portion of the collector.

It may be desirable to accurately quantify the weight or mass of grounds in the grounds collector, for example to ensure that an accurately pre-determined weight or mass of coffee grounds is transferred to a machine for brewing, in particular a filter basket of a portafilter for use in an espresso machine. This both minimizes waste and ensures consistency of the quality of the resulting brewed beverage.

In order to address this issue, a second aspect of the invention is provided. In the second aspect of the invention, there is provided a grounds collection and measurement device for use in a bean grinding apparatus, wherein the device comprises a measuring scale and a grounds collector, wherein the grounds collector comprises a receptacle having an inner wall and an outer wall wherein an inwardly facing surface of the inner wall defines a hollow within the receptacle, characterized in that the inwardly facing surface of the inner wall has a roughness measured as Ra of less than 0.8 μm and wherein a lower portion of the inwardly facing surface of the inner wall forms a substantially continuously concave surface.

In other words, the second aspect of the invention provides a grounds collection and measurement device for use in a bean grinding apparatus, wherein the device comprises a measuring scale and a grounds collector according to the first aspect of the invention. It will be appreciated that the optional features of the first aspect of the invention apply equally to the device of the second aspect of the invention. Thus, the grounds collector defined in the various embodiments of the first aspect of the invention may be used with the measuring scale to form the second aspect of the invention.

A skilled person will appreciate that that in this context a measuring scale is a device for measuring mass or the resultant force, weight, and includes electronic and mechanical devices. Thus, the measuring scale may be used to measure the mass or weight of a ground product located within the grounds collector.

Suitably, the grounds collection and measurement device comprises a display which displays the output of the measuring scale. Suitably the measuring scale is an electronic measuring device and the display is a liquid crystal display (LCD). Suitably the measuring scale comprises a tare function such that weight of grounds contained in the grounds collector may be weighed by difference.

In one embodiment, the grounds collection and measurement device comprises a locating aperture in a body portion of the measuring scale. Suitably, the locating aperture is configured to cooperate with a protuberance located on the bean grinding apparatus such that the grounds collection and measurement device may detachably couple to the bean grinding apparatus in use.

In this context, the term “aperture” includes a through-hole formed through a portion of the body, a cavity formed in a portion of the body and a notch formed in a peripheral edge portion of the body.

The grounds collection and measurement device may be a single component comprising the measuring scale and the grounds collector in a unified body.

Alternatively, the collection and measurement device may be a two-part component comprising a lower part which comprises the measuring scale and a detachable upper part which comprises the grounds collector. Thus, the grounds collector may be detachably coupled to a body portion of the measuring scale.

Suitably, lower part which comprises the measuring scale and the detachable upper part which comprises the grounds collector are configured to cooperate in use.

More suitably, a lower portion of the outer wall of the grounds collector and an upper surface of the measuring scale are configured to cooperate in use. For example, the upper (i.e. upwardly facing) surface of the measuring scale may define a recess which is sized and shaped to receive a lower portion of the outer wall of the grounds collector. The grounds collector may form a friction fit within the recess. Alternatively, the measuring scale and the grounds collector may include a latching mechanism that is capable of releasably securing the grounds collector to the measuring scale.

As noted above, the grounds collection and measurement device may comprise a locating aperture in a body portion of the measuring scale, wherein the locating aperture may be configured to receive a locating lug or locating pin carried by the bean grinding apparatus such that the grounds collection and measurement device may be detachably coupled to the bean grinding apparatus in use. Accordingly, in one embodiment, the lower part of the measuring scale further comprises a locating aperture. Suitably, the locating aperture is configured to cooperate with a protuberance carried by the bean grinding apparatus such that the grounds collection and measurement device may detachably couple to the bean grinding apparatus in use.

The features of the second aspect of the invention may be combined with the features of the first aspect of the invention. Thus, the arrangements described hereinabove in connection with the second aspect of the invention may form one or more embodiments of the apparatus as defined above in connection with the first aspect of the invention. In other words, the second aspect of the invention may define embodiments of the first aspect of the invention.

The skilled person will appreciate that the features described and defined in connection with the aspects of the invention and the embodiments thereof may be combined in any combination, regardless of whether the specific combination is expressly mentioned herein. Thus, all such combinations are considered to be made available to the skilled person.

### BRIEF DESCRIPTION OF THE DRAWINGS

An embodiment of the invention will now be described, by way of example only, with reference to the accompanying drawings in which:

FIG. 1 is a side view of the grounds collector according to the invention;

FIG. 2 is a plan view from above of the grounds collector shown in FIG. 1;

FIG. 3 is a vertical cross section view of the grounds collector shown in FIG. 1 taken along A-A;

FIG. 4 is a side view of the grounds collection and measurement device according to the invention;

FIG. 5 is a plan view from above of the grounds collection and measurement device shown in FIG. 4;

FIG. 6 is a vertical cross-section view of the grounds collection and measurement device shown in FIG. 4 taken along A-A;

For the avoidance of doubt, the skilled person will appreciate that in this specification, the terms “up”, “down”, “front”, “rear”, “upper”, “lower”, “width”, etc. refer to the orientation of the components as found in the example when installed for normal use as shown in the Figures.

### DETAILED DESCRIPTION

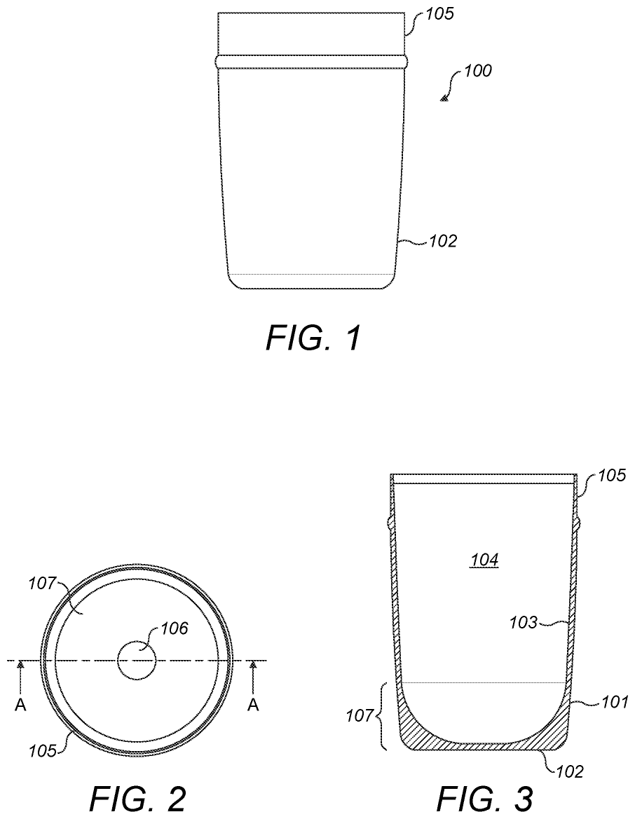

As shown in FIGS. 1, 2, and 3, grounds collector 100 comprises a receptacle with an inner wall 101 and an outer wall 102 wherein an inner surface 103 of the inner wall 101 defines a hollow 104 within the receptacle. The outer wall 102 is manufactured from stainless steel 1.4301 (304; EN 10088-3:2005) The inner wall 101 is manufactured from stainless steel 1.4301 (304; EN 10088-3:2005) and the inner wall 101 and outer wall 102 are welded at an upper lip 105 of the receptacle, which defines a circle of radius 58 mm. The inner surface 103 of the inner wall 101 is bright polished. A lower portion 107 of the inner surface 103 of inner wall 101 is substantially continuously concave, including a central planar horizontal portion 106 having a radius of 8 mm.

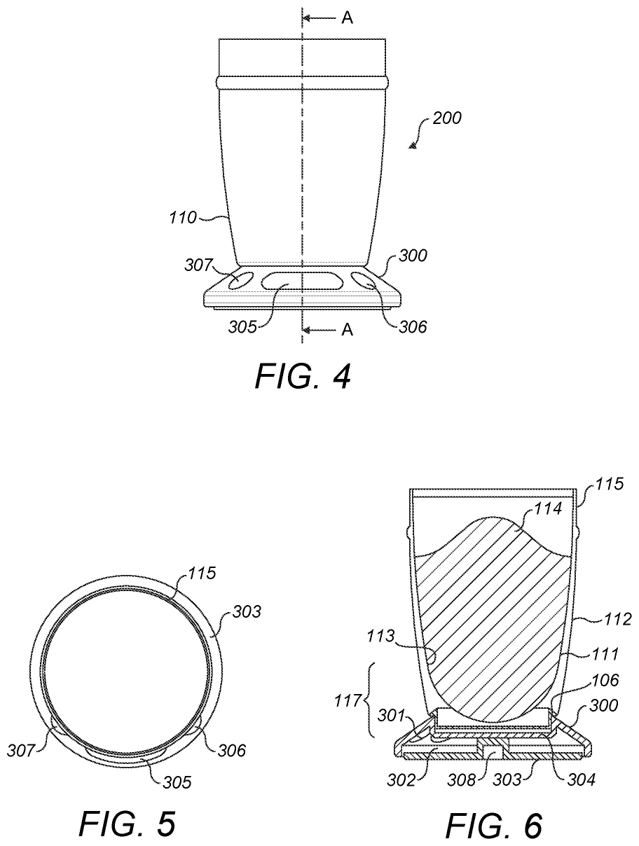

As shown in FIGS. 3, 4, and 5, grounds collection and measurement device 200 comprising a grounds collector 110 and a measuring scale 300 in a unified body. The grounds collector 110 comprises a receptacle formed from an inner wall 111 and an outer wall 112 wherein an inner surface 113 of the inner wall 111 defines a hollow 114 within the receptacle. The outer wall 112 is manufactured from stainless steel 1.4301 (304; EN 10088-3:2005) The inner wall 111 is manufactured from stainless steel 1.4301 (304; EN 10088-3:2005) and the inner wall 111 and outer wall 112 are welded at a top lip 115 which defines a circle of radius 58 mm. The inner surface 113 of the inner wall 111 is bright polished. A lower portion 117 of the inner surface 113 of inner wall 111 is continuously concave.

A cylindrical lower locating portion 116 of the outer wall 112 defines a locating portion for locating the grounds collector 110 in the correct location relative to the measuring scale 300.

The measuring scale 300 comprises a weight measuring beam 301 mounted on a base 302. The weight measuring beam 301 and base 302 are housed in a housing 303.

Defined above the weight measuring beam 301, the housing 303 defines a cylindrical receiving recess 304. The diameter of the receiving recess 304 is slightly greater than the diameter of the cylindrical lower locating portion 116 of the grounds collector 110 such that the grounds collector can be located correctly relative to the measuring scale 300.

In use, the grounds collector 110 is mounted on the weight measuring beam 301. An LCD 305, which displays the output the measuring scale 300, is mounted in the housing 303. The measuring scale 300 is operated via a power (on/off) button 306 mounted in the housing 303 The measuring scale 300n comprises a tare function and a tare button 307 to tare the measuring scale 300 mounted in the housing 303. The bottom surface 307 of the grounds collection and measurement device 200 defines a locating aperture 308. The locating aperture 308 is shaped and sized to receive a locating lug carried by a bean grinding apparatus (not shown), such as the apparatus described in WO2018/211264.

1-16. (canceled)

17. A grounds collector comprising:
a receptacle with an inner wall and an outer wall;
wherein an inwardly facing surface of the inner wall defines a hollow within the receptacle;
wherein the inwardly facing surface of the inner wall has a roughness measured as Ra of less than 0.8 μm; and
wherein a lower portion of the inwardly facing surface of the inner wall forms a substantially continuously concave surface.

18. The grounds collector according to claim 17, wherein a radius of curvature of the inwardly facing surface of the inner wall is greater than 5 mm.

19. The grounds collector according to claim 17, wherein a bottom portion of the inwardly facing surface of the inner wall includes a central planar portion wherein a first diameter of the central planar portion is less than 25% of a second diameter of the grounds collector receptacle.

20. The grounds collector according to any of claim 17, wherein the roughness measured as Ra of the inwardly facing surface of the inner wall is less than 0.2 μm.

21. The grounds collector according to any of claim 17, wherein the inwardly facing surface of the inner wall comprises polished stainless steel.

22. The grounds collector according to any of claim 17, further comprising a connecting portion connecting the inner wall to the outer wall.

23. The grounds collector according to claim 22, wherein the inner wall is spaced from the outer wall other than at the connecting portion.

24. The grounds collector according to claim 17, further comprising a weighted element disposed between the inner wall and the outer wall.

25. The grounds collector according to claim 24, wherein the weighted element is located at a bottom portion of the grounds collector.

26. A grounds collection and measurement device for use in a bean grinding apparatus, comprising:
a measuring scale; and
a grounds collector, the grounds collector including a receptacle with an inner wall and an outer wall;
wherein an inwardly facing surface of the inner wall defines a hollow within the receptacle;
wherein the inwardly facing surface of the inner wall has a roughness measured as Ra of less than 0.8 μm; and
wherein a lower portion of the inwardly facing surface of the inner wall forms a substantially continuously concave surface.

27. The grounds collection and measurement device according to claim 26, further comprising a display configured to display an output of the measuring scale.

28. The grounds collection and measurement device according to claim 26, wherein the measuring scale includes a tare function.

29. The grounds collection and measurement device according to claim 26, further comprising a locating aperture defined in a body portion of the measuring scale.

30. The grounds collection and measurement device according to claim 26, wherein the device is a unitary component comprising the measuring scale and the grounds collector in a common body.

31. The grounds collection and measurement device according to claim 26, wherein the device is a two-part component comprising a lower part which comprises the measuring scale and a detachable upper part which comprises the grounds collector.

32. The grounds collection and measurement device according to claim 31, wherein an upper surface of a measuring scale body defines a recess which is sized and shaped to receive a lower portion of the outer wall of the grounds collector.
